(19) United States
(12) Patent Application Publication
(10) Pub. No.: US 2013/0138498 A1
(43) Pub. Date: May 30, 2013

(54) FLASH SALE

(71) Applicant: Robyn R. Schwartz, Chicago, IL (US)

(72) Inventor: Robyn R. Schwartz, Chicago, IL (US)

(73) Assignee: INTERNATIONAL BUSINESS MACHINES CORPORATION, Armonk, NY (US)

(21) Appl. No.: 13/307,233

(22) Filed: Nov. 30, 2011

(51) Int. Cl. G06Q 30/02

(52) U.S. Cl. 705/14.35

(57) ABSTRACT

A retail store computer identifies potential customers who are located in or near a merchant store at a point in time using communication with their personal mobile devices. GPS or presence technology may facilitate performing the location function. The potential customers are then grouped into a buying group by the computer based on a profile. The profile may include a customer segment, an action cluster, a demographic, or buying habits. The computer then makes an immediate dynamic buying opportunity via the personal mobile devices to the buying group based on the profile, store profitability, and current business drivers. Acceptance may be tracked to determine whether a pre-specified participation has been reached.

### FIELD OF THE INVENTION

The invention relates to use of flash mob technology, including use of personal portable devices by large numbers of otherwise unrelated individuals by a retail merchant for increasing sales of retail items. More specifically, the invention relates to spontaneous volume marketing of retail items via social networks based on a margin attainment goal, profitability, or business drivers, such as current stock or overstock.

### BACKGROUND OF THE INVENTION

Pervasive use of personal mobile devices coupled with social networking applications has led to spontaneous events involving relatively large numbers of people assembling in specific locations. The present invention makes use of this technology in a unique way to facilitate transactions between a merchant and large numbers of potential customers.

A merchant attains a margin goal for current business drivers, such as current stock or overstock by identifying potential customers into a buying group at a point in time. Other eligible participants across other channels, such as store, web, call center, or kiosk, may be added to the buying group.

An immediate dynamic buying opportunity is presented to the buying group. Acceptance may be tracked via time stamp to determine whether a required participant level is achieved.

### SUMMARY OF THE INVENTION

Embodiments of the present invention provide a system, method, and program product to facilitate transaction between a merchant and a dynamic buying group of customers. A store computer identifies a plurality of potential customers located in or near the store from their personal mobile devices. The computer groups a subset of the potential customers into a buying group based on a profile. The computer then makes an immediate buying offer to the buying group via their personal mobile devices. The offer is based upon the profile, store profitability, and current business drivers.

In other embodiments, the computer may use GPS or presence technology to more accurately determine the customer's location. The profile used to form the buying group may comprise a customer segment, an action cluster, a demographic, or buying habits. The computer may require achieving a pre-specified participation level for the buying opportunity to take effect.

In other embodiments, customers from other channels, e.g., store, web, call center, pop-ups or kiosk may be added to the buying group based on the profile, and receive the immediate dynamic buying opportunity also across their channel.

### BRIEF DESCRIPTION OF THE SEVERAL VIEWS OF THE DRAWINGS

FIG. 1 is a functional block diagram of a system for implementing the present invention;

FIG. 2 is a flowchart illustrating the basic operational steps of an embodiment of the present invention; and

FIG. 3 is a block diagram of hardware and software within and external to the computer of FIG. 1 in accordance with the present invention.

### DETAILED DESCRIPTION

For a better understanding of the present invention, together with other and further objects, advantages, and capabilities thereof, reference is made to the following disclosure and the appended claims in connection with the above-described drawings.

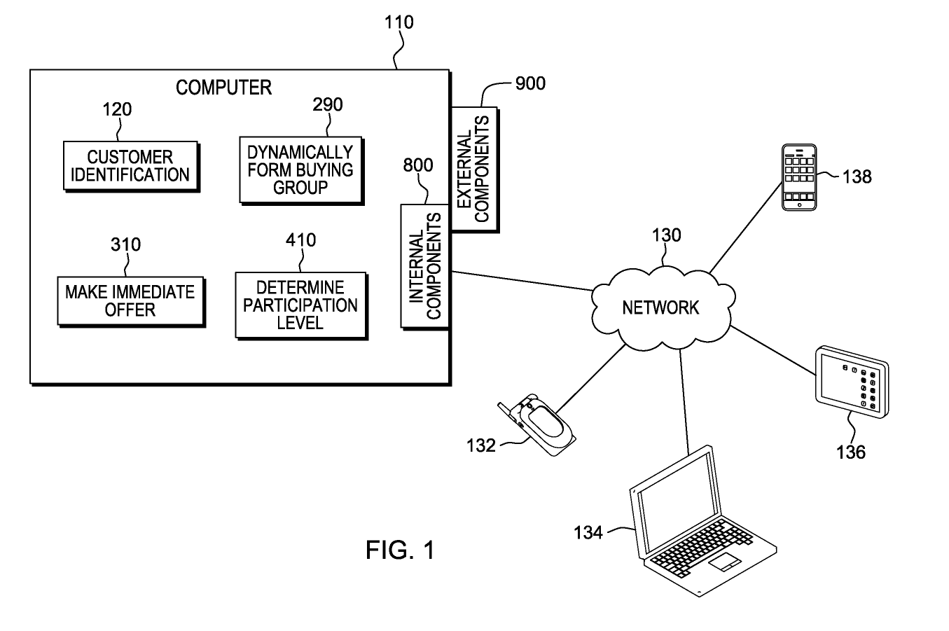

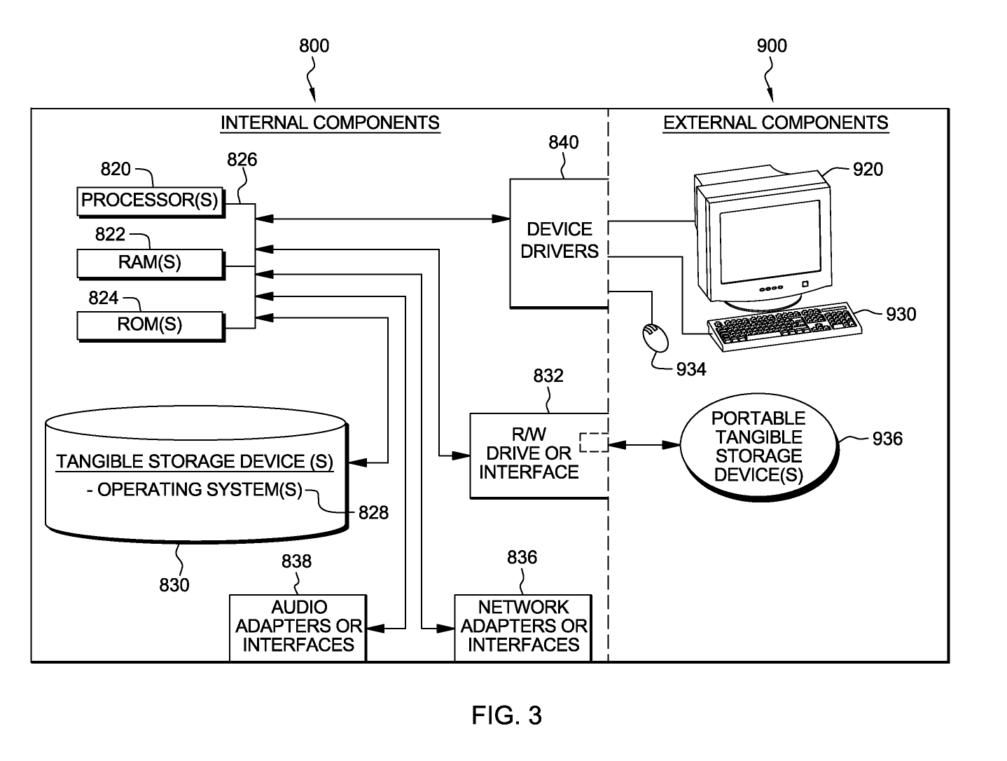

In FIG. 1, there is shown computer 110 having both internal components 800 and external components 900 as described below in connection with FIG. 3. Computer 110 also has various functions stored within for performing individual steps of the present invention. Customer identification function 120 communicates with personal mobile devices, such as, cell phones 132, palmtop/laptops 134, tablets 136, or smart phones 138 via network 130 attached to internal components 800. Any type of personal, portable device known in the art may be used. Attachment to network 130 is preferably via a wireless protocol, such as wi-fi, to a hot spot or via a cellular tower; however, any network technology known in the art may be used, including, but not limited to infrared, radio, wired, Ethernet®, fiber cable, DSL, dial-up, or direct wires.

Computer 110 attaches to network 130 via internal components 800 using any of the above technologies.

Based on communication with the personal, portable devices, customer identification function 120 is able to identify potential customers in or near a merchant store at a point in time. Point in time shall be taken herein to mean a brief period during which the set of identified potential customers remains substantially the same.

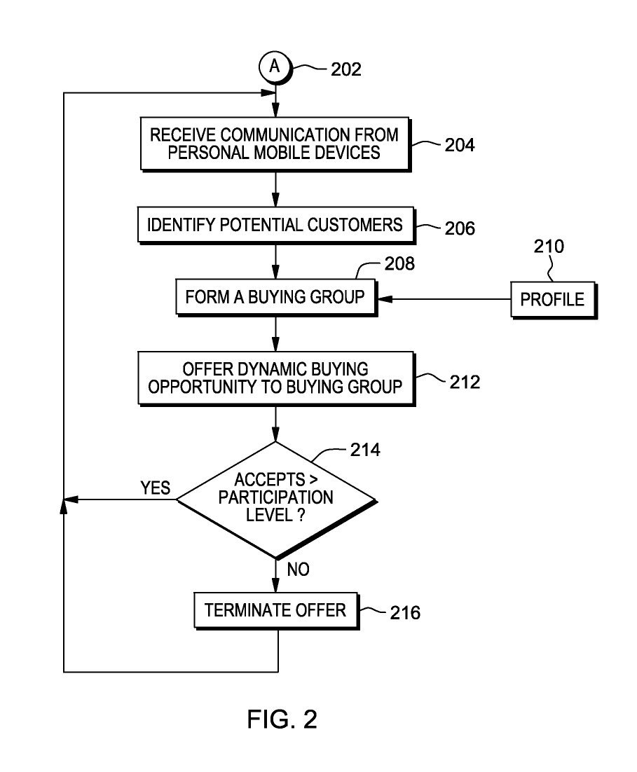

Computer 110 also has a function 290 for dynamically forming a buying group from the set of potential customers. Computer 110 also has functions for making an immediate offer 310, and for determining the participation level 410 of those in the buying group. A more detailed description function 120, 290, 310, and 410 is given below in connection with FIG. 2. More detailed structure is described below in connection with FIG. 3.

In FIG. 2, there is shown a flowchart depicting the steps required to practice embodiment of the present invention. The process starts at (A) step 202. In step 204, computer 110 receives communications via network 130 from a plurality of personal mobile devices, such as 132, 134, 136, or 138. The communication includes information which allows computer 110 to determine that the personal mobile device and therefore its owner is in or near a merchant store. Various location technologies known in the art, such as, but not limited to a GPS receiver in the mobile device, triangulation between cell phone towers, presence technology, or social networking may be used to make the location determination. A pre-specified vicinity of the store is set and all devices/owners within the vicinity are identified as potential customers in set 206. The vicinity specified may depend on the type of merchandise sold in the store, store size, or type of community where the store is located, e.g., downtown, suburb, shopping mall, rural. The brief period used for a point in time may also depend upon such considerations, as well as others.

In step 208, a subset of the potential customers is grouped into a buying group during the point in time, using a profile from step 210. The profile may define a customer segment based on demographics. Demographics can include customer attributes, such as, but not limited to age, gender, income level, race, ethnicity, disabilities, marriage status, family size, education, transactional history and characteristics, and social or collective thinking. The profile may also define an action cluster, which shall be taken herein to mean a customer segment based on customer actions taken in the past. The profile may also define based on buying habits, such as, but not limited to past transactions, responsiveness to promotional programs, influencer network, purchase preferences, recency and frequency, and channel preferences. The profile in step 210 may be dynamically generated by computer 110 in function 290 or 310. The profile may also be retrieved from some storage, e.g. 822, 824, 830. It may also be provided by a third party, such as a manufacturer of products sold in the store.

In step 212 computer 110 using function 310 sends an immediate dynamic buying opportunity to customer in the buying group using their personal mobile devices. The opportunity is based on the profile, store profitability targets, and current business drivers, such as current stock, overstock. There may be a participation level requirement or time limit, such as each acceptance must occur within the point in time.

Customers can immediately proceed to the store to accept the offer, forming a mob within the store. Customers may also accept via their portable device for pick up at a later time.

In some embodiments, customers using other channels, such as web, call center, kiosk, pop-ups may be added to the buying group based on the profile. In this case, these customers will also receive the immediate dynamic buying offer via their channel. They may also proceed to the store to accept the offer adding to the mob. They may also accept the offer over their alternate channel for later pick up.

In some embodiments, acceptances of the offer are tracked via a time stamp. In step 214, total acceptances are compared to a required participation level. If greater, the offer is a success and computer 110 proceeds back to start the process over on a new flash sale. If the participation level is not reached, the offer is terminated or cancelled in step 216 depending on the offer terms. Computer 110 again proceeds to start the process for a new offer.

FIG. 3 shows a block diagram of internal components 800 and external components 900 of a computer 110, in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Computer 110 is representative of any electronic device capable of executing machine-readable program instructions. Computer 110 may be representative of a computer system or other electronic devices. Examples of computing systems, environments, and/or configurations that may represented by computer 110 include, but are not limited to, personal computer systems, server computer systems, thin clients, thick clients, laptop devices, smart phones, multiprocessor systems, microprocessor-based systems, network PCs, minicomputer systems, and distributed cloud computing environments that include any of the above systems or devices.

Computer 110 includes a set of internal components 800 and external components 900. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, functions 120, 290, 310, and 410, in computer device 110 are stored on one or more of the respective computer-readable tangible storage devices 830 for execution by one or more of the respective processors 820 via one or more of the respective RAMs 822 (which typically include cache memory). In the embodiment illustrated in FIG. 3, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. Functions 120, 290, 310, and 410, in computer 110 can be stored on one or more of the respective portable computer-readable tangible storage devices 936, read via the respective R/W drive or interface 832 and loaded into the respective hard drive 830.

Internal components 800 also includes audio adapters or interfaces 838 such as a sound card, hardware mixer, amplifier, or other adapters or interfaces for receiving audio signals from microphones.

Internal components 800 also includes network adapters or interfaces 836 such as a TCP/IP adapter cards, wireless wi-fi interface cards, or 3G or 4G wireless interface cards or other wired or wireless communication links. Functions 120, 290, 310, and 410, in computer 110 can be downloaded to computer 110 from an external computer via a network (for example, the Internet, a local area network or other, wide area network) and respective network adapters or interfaces 836. From the network adapters or interfaces 836. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the appended claims.

What is claimed is:

1. A method of facilitating transactions between a merchant and a dynamic buying group of customers, comprising:
at a point in time, identifying at a store computer, a plurality of potential customers in or near a merchant store from personal mobile devices;
the computer dynamically grouping a subset of said plurality of potential customers into a buying group based on a profile; and
offering, via said personal mobile devices, an immediate dynamic buying opportunity to said buying group based on said profile, store profitability, and current business drivers.

2. The method of claim 1, wherein said personal mobile device comprises a smart phone, a portable computer, a tablet computing device, or an in-store portable computing device.

3. The method of claim 2, wherein said personal mobile device includes GPS or presence technology.

4. The method of claim 1, wherein said profile comprises a customer segment, an action cluster, a demographic, or buying habits.

5. The method of claim 1, wherein said buying opportunity requires a pre-specified participation level.

6. The method of claim 1, wherein said opportunity has an acceptance time stamp.

7. The method of claim 1, wherein said opportunity includes enablement of on-line acceptance via said personal mobile devices.

8. A system for facilitating transactions between a merchant and a dynamic buying group of customers, comprising:
a plurality of mobile devices carried by a corresponding plurality of potential customers located in or near a merchant store at a point in time;
a store computer for identifying said potential customers from communication with said mobile devices and for grouping a subset of said potential customers into a buying group based on a profile; and
dynamic buying opportunity program code running on said store computer for offering via said personal mobile devices, an immediate dynamic buying opportunity to said buying group, based on said profile, store profitability, and current business drivers.

9. The system of claim 8, wherein said personal mobile device comprises a smart phone, a portable computer, a tablet computing device, or an in-store portable computing device.

10. The system of claim 9, wherein said personal mobile device includes GPS or presence technology.

11. The system of claim 8, wherein said profile comprises a customer segment, an action cluster, a demographic, or buying habits.

12. The system of claim 8, wherein said buying opportunity requires a pre-specified participation level.

13. The system of claim 8, wherein said opportunity has an acceptance time stamp.

14. The system of claim 8, wherein said opportunity includes enablement of on-line acceptance via said personal mobile devices.

15. A computer program product for instructing a processor to facilitate transactions between a merchant and a dynamic buying group of customers, said computer program product comprising:
a computer readable storage medium;
first program instruction means for identifying at a store computer, a plurality of potential customers in or near a merchant store at a point in time, from personal mobile devices carried by said potential customers;
second program instruction means for dynamically grouping a subset of said plurality of potential customers into a buying group based on a profile; and
third program instruction means for offering, via said personal mobile devices, an immediate dynamic buying opportunity to said buying group based on said profile, store profitability, and current business drivers; and wherein
all said program instruction means are recorded on said medium.

16. The computer program product of claim 15, wherein said personal mobile device includes GPS or presence technology.

17. The computer program product of claim 15, wherein said profile comprises a customer segment, an action cluster, a demographic, or buying habits.

18. The computer program product of claim 15, wherein said buying opportunity requires a pre-specified participation level.

19. The computer program product of claim 15, wherein said opportunity has an acceptance time stamp.

20. The computer program product of claim 15, wherein said opportunity includes enablement of on-line acceptance via said personal mobile devices.
